(19) United States
(12) Patent Application Publication
(10) Pub. No.: US 2012/0256067 A1
(43) Pub. Date: Oct. 11, 2012

(54) GOLF CLUB TOWEL ASSEMBLY

(76) Inventor: David Dastrup, Escondido, CA (US)

(21) Appl. No.: 13/442,619

(22) Filed: Apr. 9, 2012

Related U.S. Application Data
(60) Provisional application No. 61/473,275, filed on Apr. 8, 2011.

(51) Int. Cl. A63B 57/00; B23P 17/00; B23P 11/00

(52) U.S. Cl. 248/225.21; 29/428; 29/525.03

(57) ABSTRACT

An assembly is provided for carrying a golf towel, the assembly comprising a hook, a hanger and a connector connecting the hook and the hanger. The assembly can be removably attached to the shaft of a golf club. The methods of making and using the assembly are also disclosed.

### RELATED APPLICATIONS

This application claims the benefit of priority under 35 USC §119 of U.S. Provisional Application Ser. No. 61/473,275 filed Apr. 8, 2011, the entire disclosure of which is incorporated herein by reference.

### FIELD OF THE INVENTION

This invention relates generally to the field of accessories for golfing. More specifically, the invention pertains to golf towels and to assemblies for carrying such towels on a golf course.

### BACKGROUND

Golf is a popular activity and many devices and items have been developed to assist golfers in improving their game and to make the activity more comfortable and pleasurable. Among these are devices useful for carrying golf towels.

When on a golf course, golf players often carry towels with them to be used for various purposes such as for cleaning dirt, grass residue and other materials on the golf ball, club faces and/or the player's hands. Existing devices that are used for carrying towels include carabiner-type assemblies and caddies. Typically, one or more golf towels are attached to his belt or to a carabiner (i.e., a D-shaped ring equipped with a spring catch on one side) on his golf bag. This occasionally may be distracting during the round of play and presents a nuisance to the player.

Some other existing devices for carrying towels provide for clipping a caddy on a golf shaft. The towel then can be removed by pulling on the caddy or the towel. The clip thus allows for unintended disconnections of the towel. The possibility of such accidental disconnection is very undesirable.

Accordingly, better devices and assemblies for carrying golf towels are desired. The present application provides some of such improved devices and assemblies.

### SUMMARY OF THE INVENTION

According to one aspect of the invention, there is provided an assembly for carrying a golf towel, the assembly includes a hook, a hanger and a flexible connector for removably connecting the hook to the hanger, wherein the hook is configured to allow a detachable attachment of the assembly to the shaft of the golf club.

According to another aspect of the invention, there is provided a towel to be used with the assembly for carrying a golf towel, the towel being a multi-layered towel composition comprising a microfiber wet side towel, a microfiber dry side towel and a waterproof barrier layer.

According to yet another aspect of the invention, a method for placing a golf towel on the shaft of a golf club, the towel having a hanging element, the method including making an assembly for carrying a golf towel, running the assembly through the hanging element of the golf towel, and hooking the assembly to the shaft of the golf club.

### BRIEF DESCRIPTION OF THE DRAWINGS

FIG. 1A depicts schematically an exemplary assembly according to an embodiment of the invention and a towel that is used with the assembly.

FIG. 1B depicts schematically parts of an exemplary assembly according to an embodiment of the invention.

FIG. 2 depicts schematically a hook that is used in an exemplary assembly according to an embodiment of the invention.

FIGS. 3A and 3B provide further details pertaining to the used in some embodiments of the invention.

FIG. 4 depicts schematically an exemplary assembly according to an embodiment of the invention.

FIGS. 5A and 5B depict schematically side and top views, respectively, of a hanger that is used in an exemplary assembly according to an embodiment of the invention.

FIG. 6 depicts schematically an exemplary assembly according to an embodiment of the invention and a towel that is used with the assembly.

FIG. 7 depicts schematically a towel that can be used with the assembly in some embodiments of the invention.

FIGS. 8A, 8B and 8C depict schematically an exemplary assembly according to one embodiment of the invention and schematic demonstration of how the assembly can be removed from the shaft of a golf club.

### DETAILED DESCRIPTION

It is to be understood that both the foregoing general description and the following detailed description are exemplary and explanatory only and are not restrictive of the invention claimed. As used herein, the use of the singular includes the plural unless specifically stated otherwise.

As used herein, “or” means “and/or” unless stated otherwise. Furthermore, use of the term “including” as well as other forms, such as “includes,” and “included,” is not limiting and its meaning is the same as that of “comprising.”

The section headings used herein are for organizational purposes only and are not to be construed as limiting the subject matter described.

“About” as used herein means that a number referred to as “about” comprises the recited number plus or minus 1-10% of that recited number. For example, “about” 100″ (i.e., inches) can mean 95-105″ or as few as 99-101″ depending on the situation. Whenever it appears herein, a numerical range such as “1 to 20” refers to each integer or fractional unit thereof in the given range; for example and without limitation to a specific range content, “1 to 20′'” means that a specified measurement can be 1″, 2″, 3″, etc., up to and including 20″, while1.1 to 20.0″ means that a specified measurement can be 1.1″, 1.2″, 1.3″, etc., up to and including 20.0″.

### EMBODIMENTS OF THE INVENTION

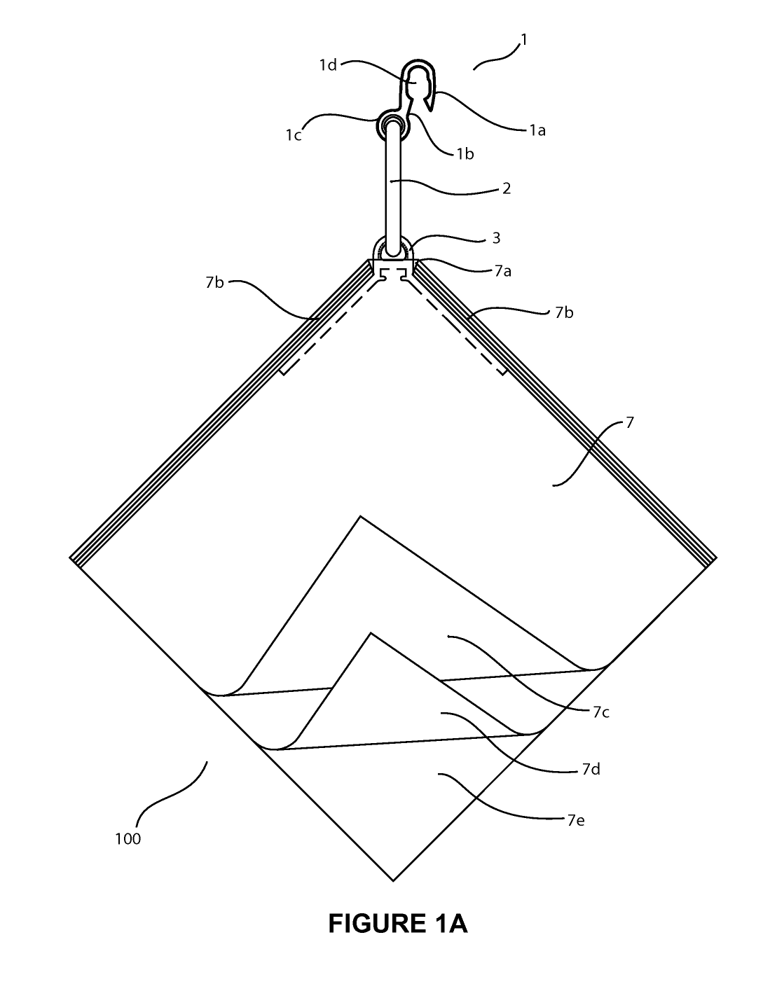

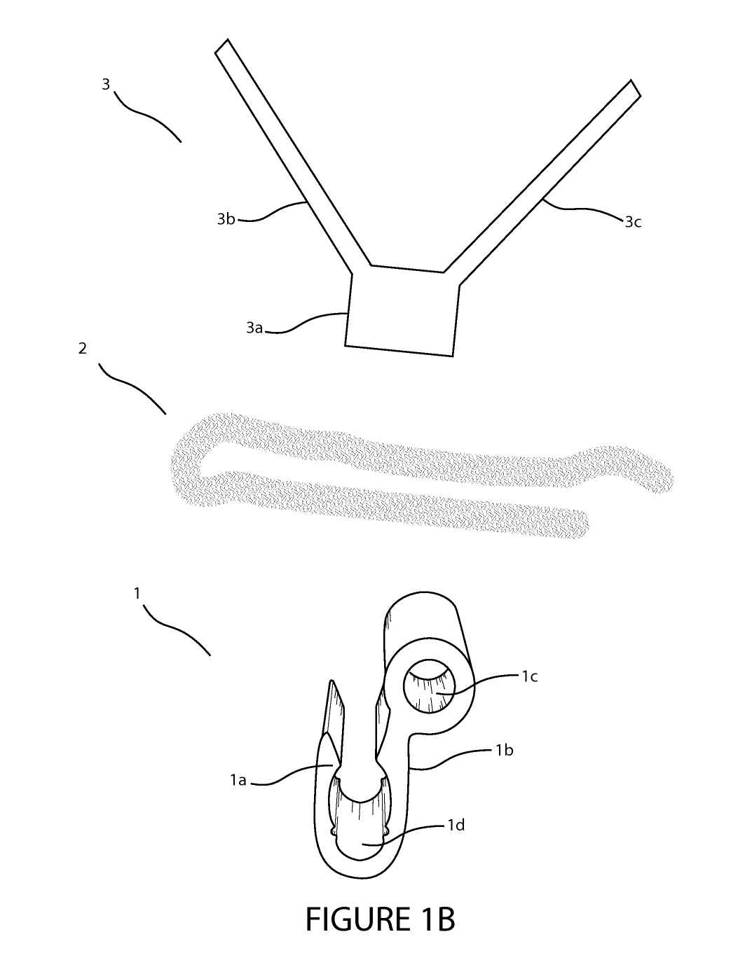

According to embodiments of the present invention, various devices are provided for carrying a towel while playing golf as well as methods for using such devices. The devices of the present invention may be generally described with the reference to FIGS. 1-7 showing, but not limited to, certain exemplary embodiments of the invention.

More specifically, FIGS. 1A, 4 and 6 depict schematically an assembly 100 for carrying a towel while playing golf according to one embodiment of the present invention. The assembly comprises a hook 1 having a hooking section 1a, an eyelet section 1c and a connecting section 1b that connects the hooking section 1a to the eyelet section 1c. The hooking section 1a taken together with the connecting section 1b define the cavity 1d that is used for attaching the hook to the shaft of the golf club (not shown) as described in more detail below.

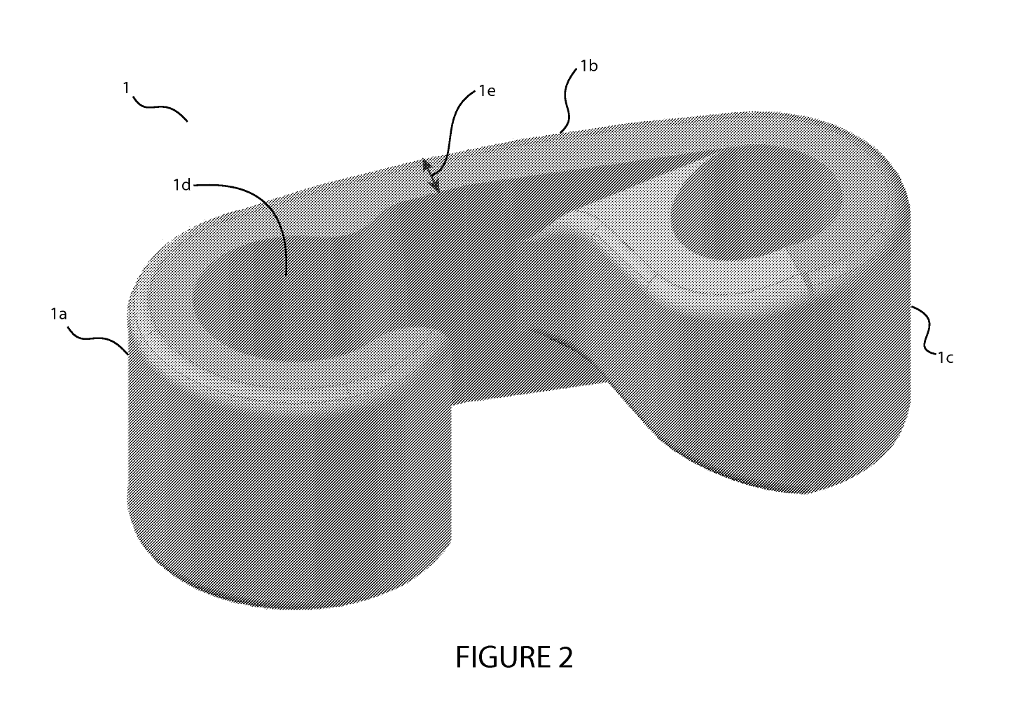

The hook 1 shown in more detail on FIGS. 1B, 2, 3A and 3B can be fabricated of any suitable material. Examples of suitable materials include, but are not limited to, glass-filled nylon or another sturdy plastic material, or a metal, such as stainless steel, aluminum or bronze. Another suitable material may be selected, if desirable, by those having ordinary skill in the art. The hook 1 can have the thickness 1e (FIG. 2) between about ⅛″ and about ⅝″, for example, about ⅜″.

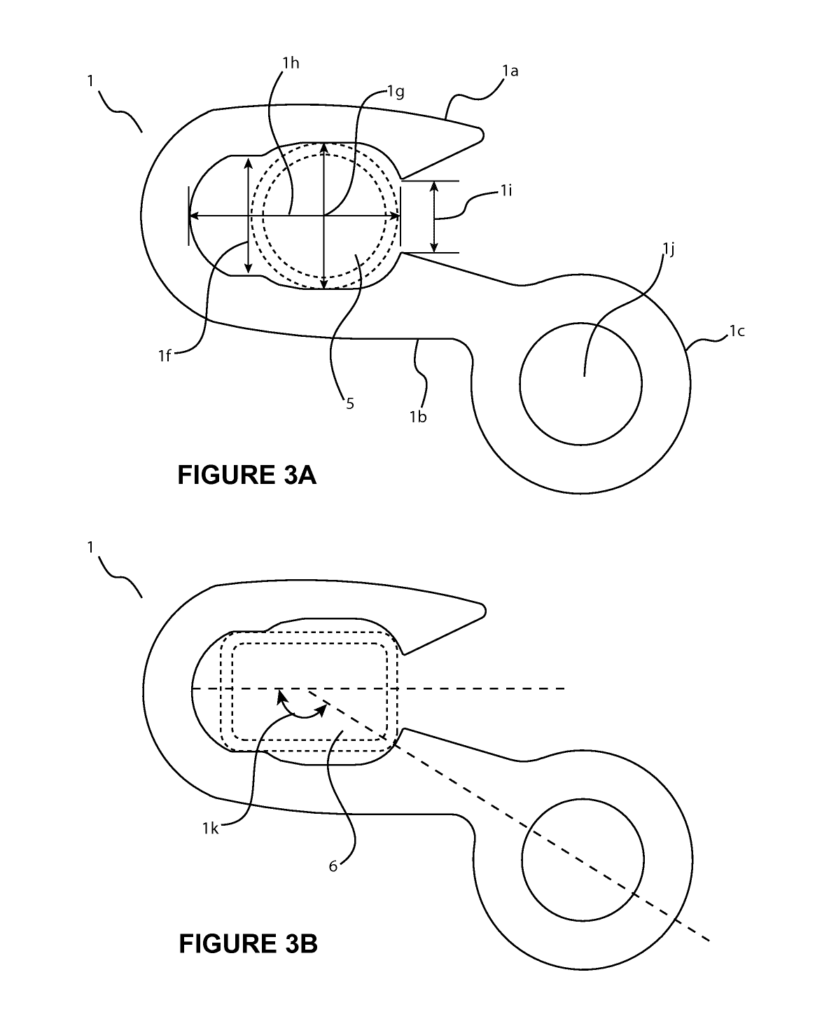

The hook 1 can be manufactured by any suitable method to be selected by those having ordinary skill in the art. One example of the manufacturing technique that can be used is injection molding plastic. Alternative fabrication methods include machining, water jet cutting and laser cutting. The hook 1 so fabricated includes the cavity 1d comprising two distinct curved portions, i.e., a narrower curved portion and a wider curved portion, the two curved portions being adjacent to, and integrated with, each other, as illustrated by FIGS. 3A and 3B.

The greatest dimension if of the narrower curved portion can be between about 0.25″ and about 0.35″, such as between about 0.30″ and about 0.31″, for example, about 0.3077″. The greatest dimension 1g of the wider curved portion can be between about 0.30″ and about 0.50″, such as between about 0.35″ and about 0.40″, for example, about 0.3750″. The total length 1h of the cavity 1d can be between about 0.4″ and about 0.7″, such as between about 0.5″ and about 0.6″, for example, about 0.5481″ and the width 1i at the opening point of the cavity 1d can be between about 0.15″ and about 0.25″, such as between about 0.16″ and about 0.20″, for example, about 0.189″.

As can be seen from FIG. 3A, the eyelet section 1c defines the inner cavity 1j that is essentially circular and can have the diameter between about 0.125″ and about 0.50″ such as between about 0.30″ and about 0.32″, for example, about 0.3125″. As can be also seen from FIGS. 3A and 3B, the axis of the hooking section 1a is positioned at an angle to the axis of the eyelet section 1c. This angle, 1k (FIG. 3B) can be between about 20 degrees and about 140 degrees, for example, between about 30 degrees and 45 degrees.

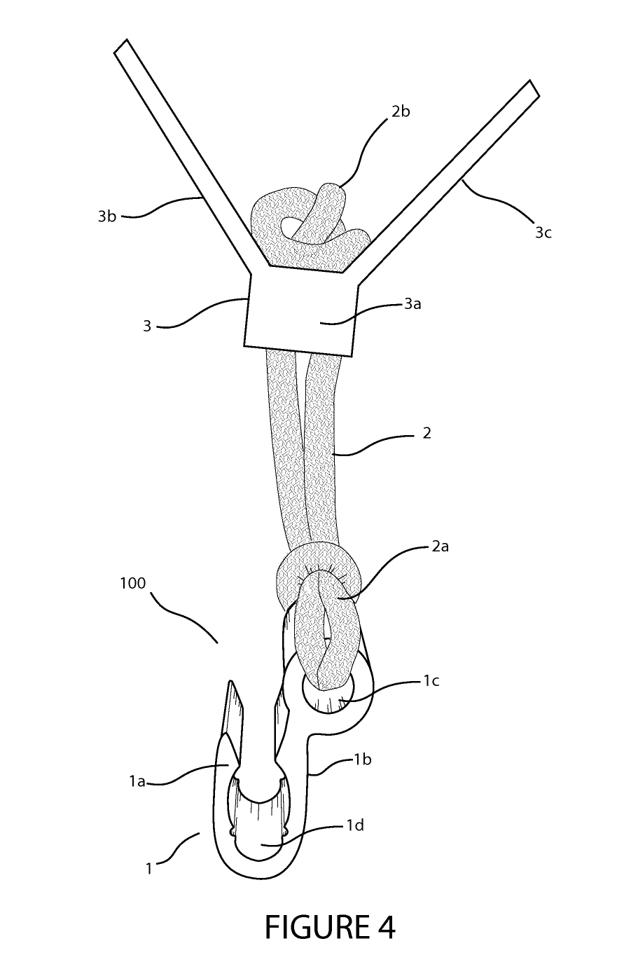

The assembly 100 further includes a lanyard 2 having two ends (also shown separately on FIG. 1B). One end of the lanyard 2 is roved through the circular opening in the eyelet section 1c of the hook 1 and the other through the opening (which can optionally be essentially circular) 3a of the hanger 3 as shown on FIGS. 1A and 4. Other means for attaching the lanyard will be apparent to those skilled in the art. The lanyard 2 is made of a suitable flexible material such as a rope, a cord, a string or a chain, for example, of a nylon rope.

The length of the lanyard 2 may be between about 1″ and about 12″, for example, between about 3″ and about 10″. The lanyard 2 may be of any thickness so long as it is possible to draw the lanyard 2 through the circular opening in the eyelet section 1c of the hook 1 and through the opening 3a of the hanger 3. Typically, the diameter of the lanyard 2 is between about 0.125″ and about 0.375″, such as about 0.25″.

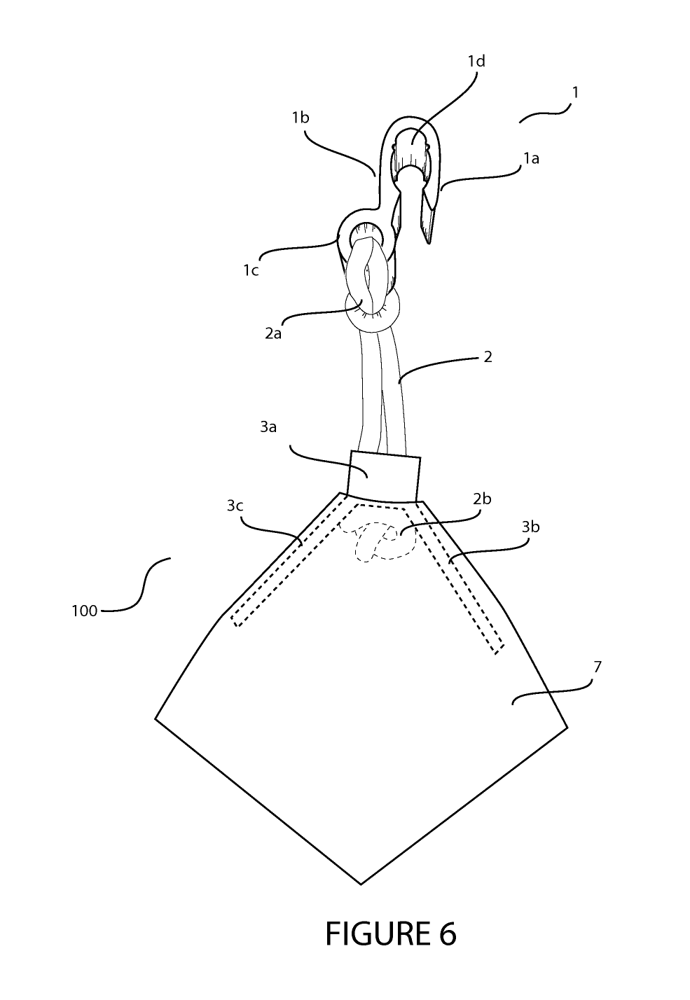

Each end of the lanyard 2 is securely but removably fastened, respectively, to the eyelet section 1c of the hook 1 and to the hanger 3, as shown on FIGS. 1A and 4. In the embodiments of FIGS. 4 and 6, the lanyard 2 is attached by making knots 2a and/or 2b, but alternatively those reasonably skilled in the art may select another feasible means of fastening, if desired, such as using loops (not shown). Thus, the lanyard 2 connects the hook 1 and the hanger 3.

The hanger 3 comprises the upper portion that contains the opening 3a mentioned above and two arms 3b and 3c integrated with the upper portion (see FIGS. 1B, 4, 5A, 5B and 6). Each of the arms 3b and 3c can have the same or a different length within the range of between about 2″ and about 5″, for example, between about 1″ and about 4″, and the ends of each of the arms 3b and 3c can be optionally rounded to avoid having sharp edges.

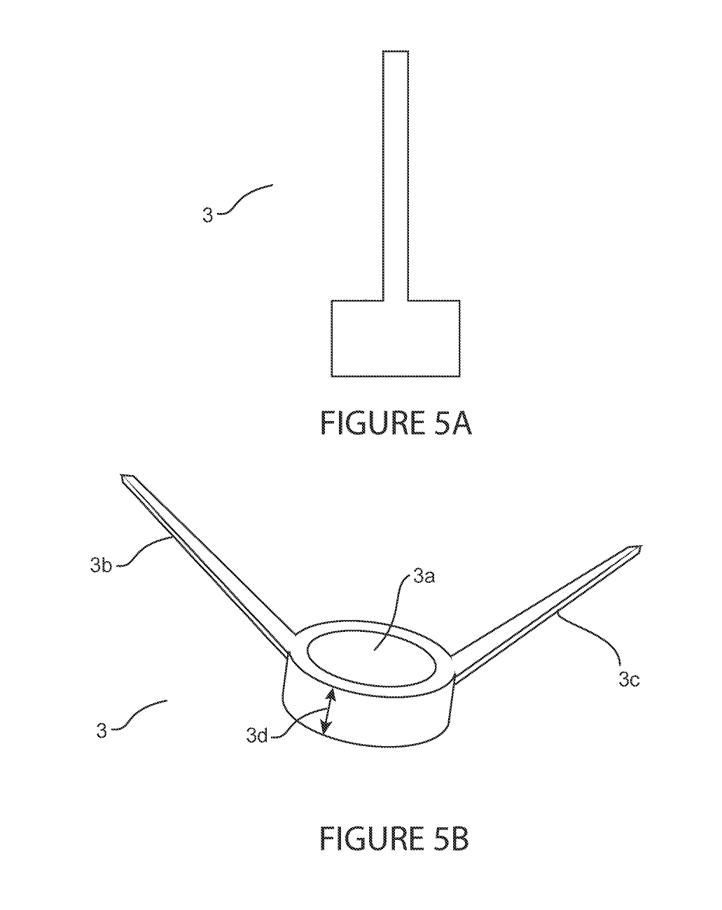

The hanger 3 can be fabricated of any suitable material. Examples of suitable materials include, but are not limited to, glass-filled nylon, another sturdy plastic material, or a metal, such as stainless steel, aluminum or bronze. Another suitable material may be selected, if desirable, by those having ordinary skill in the art. The same or different materials can be used for fabricating the hook 1 and the hanger 3. The hanger 3 can have the thickness 3d (FIG. 5B) between about 1/4″ and about 1″, for example, about 1/2″.

A towel to be used with the above described assembly would have a hanging element such as circular element 7a (FIG. 1A) made in the body of the towel, a loop, an opening or a hole in the towel. for hanging sewn to the towel. To accommodate a towel, the user will first make the assembly 100 shown on FIG. 4. The hook 1 is then inserted through this hanging element. The hook 1 is then drawn through the hanging element followed by roving the lanyard 2 through the hanging element until the towel reaches the hanger 3. The process of setting the towel on the assembly 100 ends when the towel rests upon the arms 3b and 3c of the hanger 3 as shown on FIGS. 1A and 6.

Once the towel has been installed, the user would hook the assembly 100 to a golf club. The club can be a putter or any other club. Clubs with a hosel which has either a round shape 5 (illustrated on FIG. 3A) or a rectangular shape 6 (FIG. 3B) can be accommodated. The assembly 100 thus hooks to the shaft via the hooking section 1a of the hook 1 and is securely held in place by the force of friction. Yet at the same time, the above-described features of the hook 1 allow the user to easily slide the assembly 100 up and down the shaft of the golf club, if the user so desires. The fact that the assembly 100 is attached to the shaft of the golf club instead of clips on the shaft provides a secure connection; as a result, the assembly cannot be accidentally pulled off like the clip.

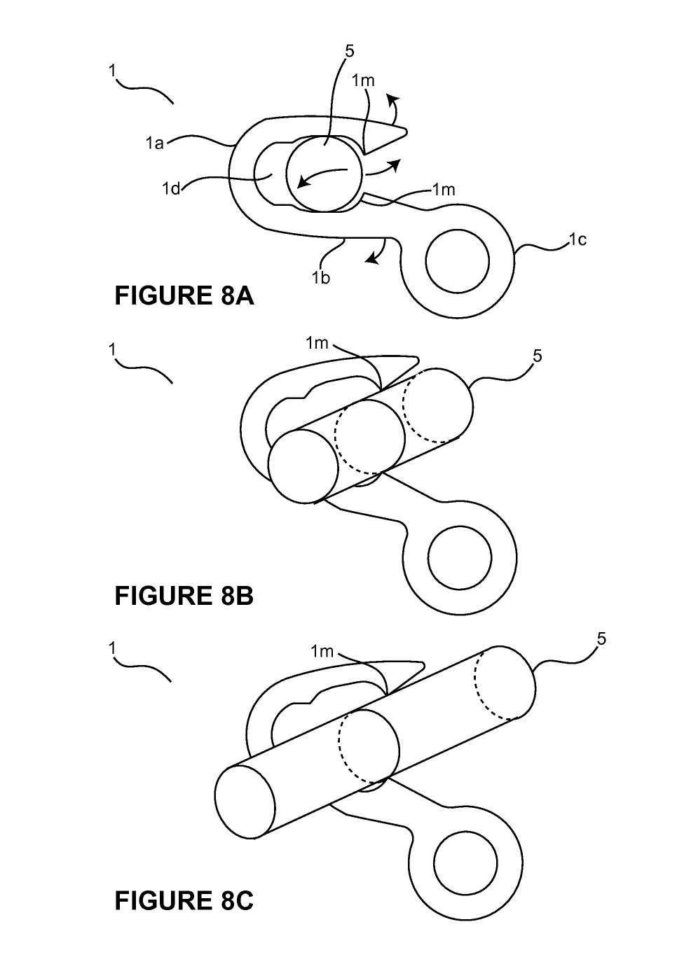

Some embodiments of the present invention also allow the user to have both the secure connection when the assembly 100 is mounted on the shaft of the club and easy removal. As shown on FIGS. 8A-8C, according to some embodiments the hook 1 includes some protruding elements or “barbs” 1m that crate the narrow opening and prevent the hook 1 from unhooking on its own. To remove the hook 1 from the shaft the user needs to rotate the hook 1 as if trying to turn the “V” shape from perpendicular to parallel the shaft (FIG. 8A). This uses the shaft to force the “V” shape open enough so the barbs 1m release from the shaft. The bevels help align the shaft in the middle of the “V” shape as the user rotates the hook 1 (FIG. 8B). The closed end 1d acts as a pivot and touches the shaft during the process of rotating forcing barbs 1m against the shaft and opening the barbs 1m (FIG. 8C). Accordingly, the hook 1 does not come off without being rotated off. The barbs 1m hold the hook 1 on the shaft and do not spread easy without the rotation maneuver described above.

When at the green the user would take the club out of the golf bag and the assembly 100 and the towel would come with the club. This means the user does not need to be concerned about remembering a towel to clean the equipment. While making a golf stroke, the user can simply twist the assembly 100 off the shaft of the club and hook it onto a pocket or belt loop so there is no need for the user to carry the assembly 100 and the towel. Once finished with that club the user would hook the assembly 100 and the towel back on the club, replace the club into the bag and continue on till the towel is needed again. Embodiments of the present invention allow for the towel to be accessible while the club is in the bag because it hangs over the edge of the bag the same as a towel attached to the bag in a regular way would hang.

Various towels are envisioned for the use with the assembly 100 described above. The towels are typically made of a microfiber terry cloth, but if desired those having ordinary skill in the art may choose towels made of another kind of fabric. In some embodiments, the towels can be rectangular or square, such as squares having the sides with the length between about 5″ and about 15″, such as 10″ by 10″ squares. The towel can have any desirable thickness, for example, between about ⅛″ and about ¼″.

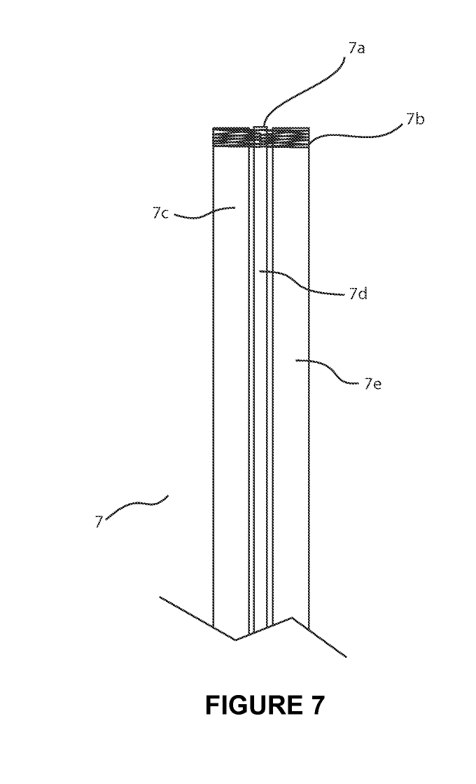

In some embodiments, multi-layer towels can be used. One such embodiment illustrated on FIGS. 1A and 7 provides for a three-layered towel 7 which can be also seen as a combination of three individual towels. One of these towels, 7c, is designated as a microfiber wet side towel. The other towel, 7e is designated as a microfiber dry side towel. The two towels 7c and 7e are separated by a waterproof barrier 7d. The waterproof barrier can be fabricated of any suitable material, such as nylon. The three layers are sewn together along the edges 7b. As can be seen from FIG. 7, the waterproof barrier 7d is even with the towel edge 7f, thus ensuring that no water will wick from the wet side 7c to the dry side 7e.

Although the foregoing invention has been described in some detail by way of illustration and example for purposes of clarity and understanding, it will be apparent to those of ordinary skill in the art in light of the teaching of this invention that certain changes and modifications may be made thereto without departing from the spirit or scope of the appended claims.

What is claimed is:

1. An assembly for carrying a golf towel, the assembly comprising:
(a) a hook, comprising a hooking section, an eyelet section and a connecting section that connects the hooking section to the eyelet section, wherein the hooking section and the connecting section define a first opening there between and the eyelet section defines a second opening;
(b) a hanger comprising an upper portion defining an essentially circular third opening, and two arms integrated with the upper portion, wherein the two arms are positioned at an angle to each other to provide the hanger with the V-shape; and
(c) a flexible connector having the first end and the second end for removably connecting the hook to the hanger, wherein the hook is configured to allow a detachable attachment of the assembly to the shaft of the golf club.

2. The assembly of claim 1, wherein the first opening further comprises:
(a) a narrower curved portion having the greatest dimension of between about 0.25″ and about 0.35″; and
(b) a wider curved portion adjacent to, and integrated with, the narrower curved portion, the wider curved portion having the greatest dimension of between about 0.30″ and about 0.50″.

3. The assembly of claim 1, wherein the first opening is characterized by a lengthwise dimension between about 0.4″ and about 0.7″.

4. The assembly of claim 1, wherein the second opening has the diameter between about 0.25″ and about 0.35″.

5. The assembly of claim 1, wherein the axis of the hooking section is positioned at an angle of between about 20 degrees and about 140 degrees to the axis of the eyelet section.

6. The assembly of claim 1, wherein each of the two arms independently has the length of between about 2″ and about 5″.

7. The assembly of claim 1, wherein each of the hook and the hanger is fabricated of a material independently selected from the group consisting of a glass-filled nylon, a plastic material and a metal.

8. The assembly of claim 1, wherein the flexible connector has the length between about 1″ and about 6″.

9. The assembly of claim 1, wherein the flexible connector is a lanyard.

10. The assembly of claim 9, wherein the lanyard is removably fastened to the hook and to the hanger by knots or loops.

11. The assembly of claim 9, wherein the lanyard is made of a nylon rope.

12. The assembly of claim 1, wherein the towel is rectangular or square having the sides with the length between about 5″ and about 15″.

13. The assembly of claim 1, wherein the towel is fabricated of a microfiber terry cloth.

14. The assembly of claim 1, wherein the towel is multi-layered composition comprising a microfiber wet side towel, a microfiber dry side towel and a waterproof barrier layer.

15. The assembly of claim 14, wherein in the multi-layered towel composition the microfiber wet side towel, the microfiber dry side towel and the waterproof barrier layer are held together by being sewn along two adjacent sides of the towel.

16. A method for making the assembly of claim 1, the method comprising:
(a) providing the hook, the hanger and the connecting element;
(b) roving the first end of the connector through the second opening in the eyelet section;
(c) fastening the first end of the connector to the hook;
(d) roving the second end of the connector through the essentially circular third opening in the upper portion of the hanger; and
(e) fastening the second end of the connector to the hanger, to thereby make the assembly of claim 1.

17. The method of claim 16, wherein the first end of the connector is fastened to the hook by forming a first knot and the second end of the connector is fastened to the hanger by forming a second knot.

18. A method for placing a golf towel on the shaft of a golf club, the method comprising:
(a) making the assembly according to the method of claim 16;
(b) providing the golf towel having a hanging element;
(c) running the assembly through the hanging element of the golf towel, so as to have the golf towel rest upon the two arms of the hanger; and
(d) hooking the assembly to the shaft of the golf club via the hooking section of the hook,
to thereby place the golf towel on the shaft of the golf club.

19. A method for removing a golf towel from the shaft of a golf club after the hooking step of claim 18 , the method comprising rotating the hook to move the hook from being perpendicular to the shaft to being parallel to the shaft, to thereby unhook the assembly from the shaft.

20. The method of claim 18, wherein the hosel of the golf club is rectangular or round.
